(19) United States
(12) Patent Application Publication
(10) Pub. No.: US 2005/0078752 A1
(43) Pub. Date: Apr. 14, 2005

(54) Method for extracting macro block at high speed in mobile communication system

(75) Inventor: Kwang-Deok Seo, Gyeonggi-Do (KR)

Correspondence Address: FLESHNER & KIM, LLP, P.O. BOX 221200, CHANTILLY, VA, 20153, US

(73) Assignee: LG Electronics Inc.

(21) Appl. No.: 10/863,340

(22) Filed: Jun. 9, 2004

(30) Foreign Application Priority Data
Oct. 13, 2003 (KR) 71161/2003

(51) Int. Cl. H04N 7/12

(52) U.S. Cl. 375/240.16; 375/240.2; 375/240.24

(57) ABSTRACT

A method for extracting a macro block at a high speed is disclosed to re-set a motion vector in a DCT (Discrete Cosine Transform) region. A macro block is extracted by using an overlap phenomenon where a previously extracted macro block information and macro block information to be currently extracted overlap with each other, so that the amount of calculation can be considerably reduced.

### BACKGROUND OF THE INVENTION

1. Field of the Invention

The present invention relates to a method for extracting a macro block at a high speed for re-setting a motion vector when a video content is manipulated in a discrete cosine transform (DCT) region.

2. Description of the Background Art

In general, video content manipulation (contraction or deletion) is a process for suitably manipulating previously stored video content according to a situation of a network and a (client's) terminal before the content is provided for service to various networks.

For example, video content manipulation processes include re-setting a transmission bit rate according to various band widths of diverse networks and controlling the resolution of the video content according to a resolution of a display unit of the terminal. The former process is called bit rate transcoding and the latter is called resolution transcoding.

In content manipulation in the DCT region, a motion vector re-setting process is commonly required for enhancing picture quality of the manipulated content.

Usually, if video content is manipulated in the DCT region, a previously obtained motion vector loses accuracy due to a change in characteristics of a manipulated image, and a new motion vector should be set.

In one technique, in order to transmit content to a network having a lower bandwidth than video content which have previously been coded and stored in a database, a process of lowering a transmission bit rate of the content by using bit rate transcoding or resolution transcoding is adopted.

In addition, in order to resolve degradation of picture quality of a finally transmitted image, a process of re-setting a motion vector is also performed.

In general, in order to re-set a motion vector in the DCT region, sums of absolute difference (SAD) in the DCT region should be compared, for which a macro block predicted by a motion vector is first extracted in the DCT region.

FIG. 1 illustrates a method for extracting a macro block in the DCT region, in which a horizontal component (mx) and a vertical component (my) of the motion vector are positive numbers.

With reference to FIG. 1, a macro block (B₀) predicted by a motion vector (mv) in the DCT region overlaps with portions of four blocks (A₀˜A₃) of a reference frame. The predicted macro block (B₀) is motion-compensated by the portions overlapping the four blocks (A₀˜A₃), and the predicted block (B₀) is expressed by a linear combination of the blocks (A₀˜A₃) by using equation (1) shown below:

$${B}_{0} = {\sum }_{i = 0}^{3} {P}_{i} {A}_{i} {Q}_{i} \qquad ( 1 )$$

wherein

$${P}_{0} = {P}_{1} = [ \begin{matrix}0 & {I}_{8 - {( my )}_{8}} \\ 0 & 0\end{matrix} ] , {P}_{2} = {P}_{3} = [ \begin{matrix}0 & 0 \\ {I}_{{( my )}_{8}} & 0\end{matrix} ] , {Q}_{0} = {Q}_{2} = [ \begin{matrix}0 & 0 \\ {I}_{8 - {( mx )}_{8}} & 0\end{matrix} ] , {Q}_{1} = {Q}_{3} = [ \begin{matrix}0 & {I}_{{( mx )}_{8}} \\ 0 & 0\end{matrix} ] ,$$

Iₙ is a unit matrix with a size of n×n, mx and my are horizontal and vertical components of the motion vector, (mx)₈ and (my)₈ are values of modulo 8 of mx and my, respectively, and 0s expressed in P₀˜P₃and Q₀˜Q₃ are a zero matrix having a certain dimension.

As a result, the predicted macro block (B₀) is obtained by a linear combination of matrices obtained by multiplying the Pi and Qi matrices determined by mx and my to the left and right of A₀˜A₃.

Equation (1) can be expressed as follows by using the unit orthogonal transform characteristics of DCT:

$${\hat{B}}_{0} = {\sum }_{i = 0}^{3} {\hat{P}}_{i} {\hat{A}}_{i} {\hat{Q}}_{i} \qquad ( 2 )$$

wherein Â=DCT(A)

Equation (2) is required for extracting one macro block. Accordingly, by applying equation (2) four times, one macro block consisting of four luminance component blocks can be extracted.

FIG. 2 shows a high speed motion vector search pattern called an HVS (Horizontal and Vertical Search) method.

The size of the search region of the HVS is [−2,+2], and there are four check points.

The HVS method searches for optimum pixel position in a horizontal direction, with a corresponding pixel indicated by an initial motion vector. Pixels positioned above and below the corresponding pixel are vertically searched to find the position of the pixel having the minimum SAD. A motion vector indicating the finally obtained pixel is a re-set motion vector that is finally obtained.

Thereafter, the method of extracting a macro block will now be described by example of the HVS method illustrated in FIG. 2.

First, a macro block indicated by the initial motion vector is extracted through equation (2), and SAD0 is obtained. A motion predicted macro block indicated by a first pixel distanced as much as one pixel position leftward from the pixel indicated by the initial motion vector is obtained through equation (2), and SAD1 is then obtained. At this time, since SAD0>SAD 1, the second pixel is checked.

A motion predicted macro block indicated by the second pixel is extracted through equation (2), and SAD2 is then obtained. In this case, since SAD1<SAD2, search in the horizontal direction is finished and the position of the horizontal directional pixel indicated by the motion vector having the minimum SAD is determined as a first pixel.

Thereafter, a motion predicted macro block indicated by a third pixel is extracted through equation (2), and SAD3 is obtained. In the case shown in FIG. 2, since SAD1>SAD3, a fourth pixel is checked. A motion predicted macro block indicated as the fourth pixel is extracted through equation (2), and SAD4 is then obtained. Since SAD3<SAD4, the vertical directional searching is finished and position of the vertical directional pixel indicated by the motion vector having the minimum SAD is determined as a third pixel.

Accordingly, the pixel indicated by the motion vector having the minimum SAD is the third pixel, and the motion vector indicating the third pixel is finally determined as the re-set motion vector.

In this manner, the macro block predicted by the motion vector is extracted in the DCT region and compared with the SAD in the DCT region, thereby re-setting the motion vector.

However, the macro block extracting method using equation (2) requires an excessive amount of calculation. That is, in equation (2), if mx and my are not a multiple of N, the number of calculations is maximized.

In this case, equation (2) is obtained from multiplication of a matrix of N×N (N=8). The number of multiplications required to obtain AB, a multiplication of A and B, the N×N matrix is N³, and the number of additions is N²(N−1). In this respect, in equation (2), since the multiplication of the matrix in the form of AB is performed eight times, the total number of multiplications is 8N³ and total number of additions is 8N²(N−1) Since this amount of calculation is made for each block, in the case of one macro block including four luminous components, 32N³ times of multiplication and 32N²(N−1) times of addition are required.

In addition, because the size of one DCT block is 8×8, if N is set to be 8, a total of 16384 times of addition and 14336 times of multiplication are required to extract one macro block. Such an excessive amount of calculation is burdensome in providing a high speed video content service, resulting in a high complexity system.

As a matter of course, if mx or my is a multiple of N, the amount of calculation would be halved, and if both mx and my are a multiple of N, the amount of calculation is ‘0’. In addition, considering the fact that the blocks used in equation (2) are DCT blocks and many coefficients are ‘0’, the amount of calculation can be reduced from the number of multiplications and the number of additions obtained as described above. This, however, is not the general case, so the excessive amount of calculation according to equation (2) needs to be improved to provide high speed video content service.

### SUMMARY OF THE INVENTION

Therefore, an object of the present invention is to provide a method for extracting a macro block at a high speed required for re-setting a motion vector.

Another object of the present invention is to provide a method for extracting a macro block capable of reducing an excessive amount of calculation in extracting the macro block.

To achieve at least the above objects, there is provided a macro block extracting method in a wireless system in which a motion vector in a DCT region is reset for a video content service between a network and a terminal, including: extracting a macro block indicated by an initial motion vector; and extracting a current macro block by using an overlap degree between the extracted macro block information and macro block information to be currently extracted.

The extracting step includes: setting an offset motion vector value by detecting an overlap degree between the previously extracted macro block information and macro block information to be currently extracted; and obtaining luminance component blocks of the current macro block by using different equations according to the set offset motion vector value.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates a basic method for extracting a macro block in the DCT region in accordance with a conventional art;.

FIG. 2 shows a high speed motion vector search pattern in an HVS (Horizontal and Vertical Search) method;

FIG. 3 illustrates positions of luminance component blocks (B₀˜B₃) belonging to a previously extracted macro block;

FIGS. 4A and 4B show examples of overlapped previously extracted macro block information and macro block information to be currently extracted;

FIGS. 5A and 5B show examples of overlapped previously extracted macro block information and macro block information to be currently extracted; and

FIG. 6 is a flow chart of a macro block extracting method in accordance with an embodiment of the present invention.

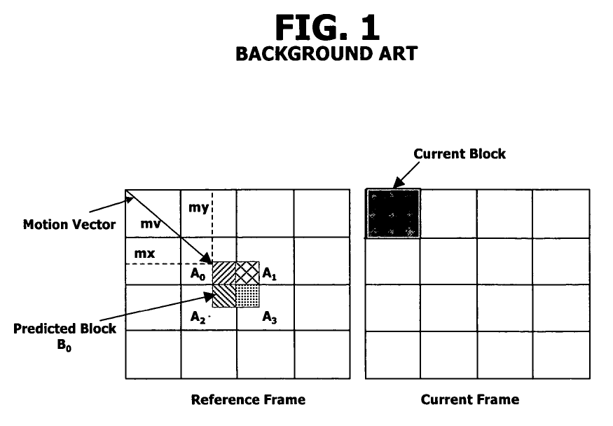

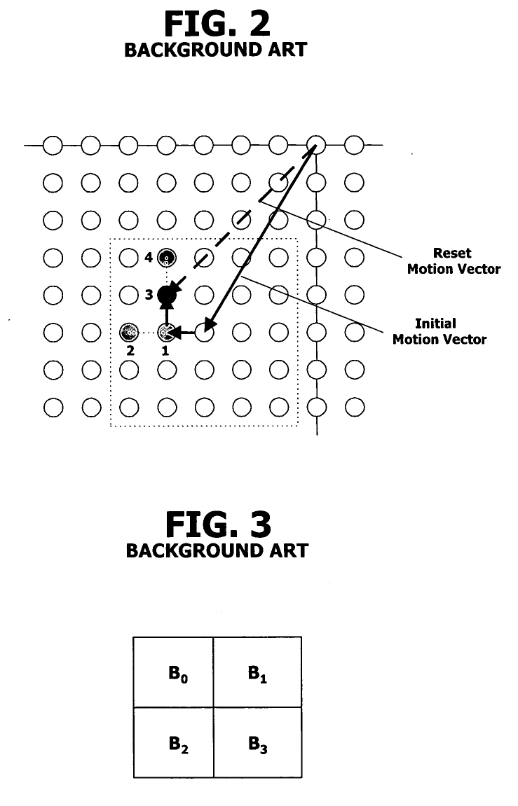

### DETAILED DESCRIPTION OF THE PREFERRED EMBODIMENTS

An embodiment of the present invention will now be described.

The present invention proposes a macro block extracting method which reduces an excessive amount of calculation.

In general, in the process of searching a re-set motion vector, there is an overlap portion of a certain degree between data information of a previously extracted macro block and data information of a macro block to be currently extracted. Thus, the present invention proposes a method for extracting a macro block by using this information overlap phenomenon.

FIG. 3 illustrates positions of luminance component blocks (B₀˜B₃) belonging to a previously extracted macro block.

With reference to FIG. 3, B₀ and B₁ indicate left/upper and right/upper blocks, while B₂ and B₃ indicate left/lower and right/lower blocks.

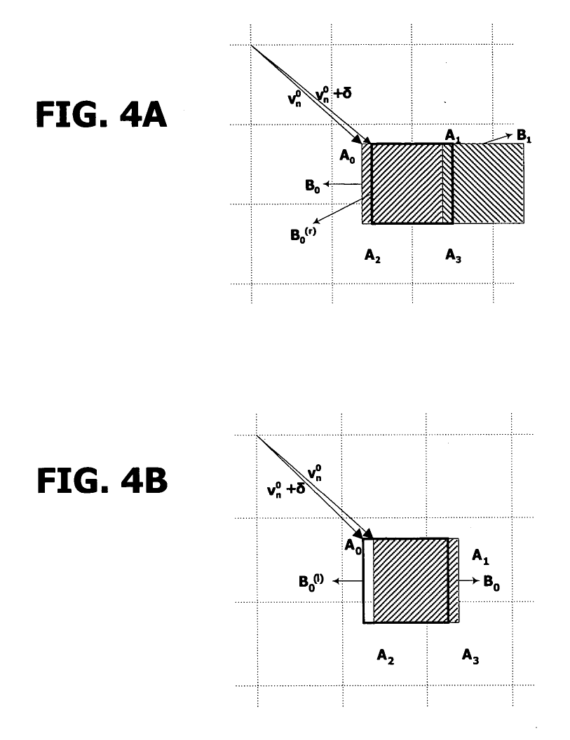

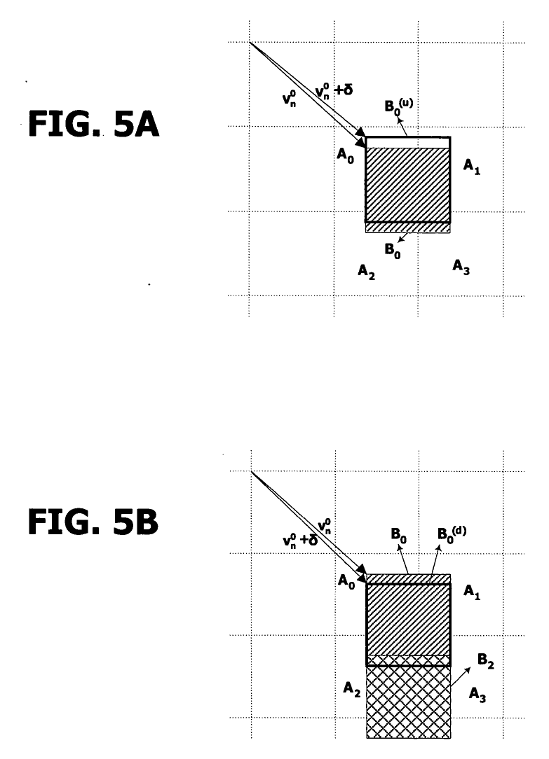

FIGS. 4A, 4B, 5A and 5B show examples of overlapped previously extracted macro block information and macro block information to be currently extracted.

First, in FIG. 4A, B₀^{(r)} signifies a left/upper block of a macro block to be currently extracted. B₀^{(r)} exists at a one pixel-shifted position rightward compared to the left block (B₀) of the previously extracted macro block. vₙ⁰ indicates an initial motion vector of the previously extracted macro block, and vₙ⁰+δ indicates a motion vector of the macro block to be currently extracted.δindicates an offset motion vector and is defined by δ ε{(1,0),(−1,0),(0,1),(0,−1)}.

Accordingly, B₀^{(r)} overlaps with B₀ by as much as 8×7 pixels, and at the same time, overlaps with B₁ by as much as 8×1 pixels. From this fact, equation (3) for extracting B₀^{(r)} can be expressed as follows:
\hat{B}₀^{(r)}=\hat{B}ₒ\hat{R}+\hat{B}₁Ŝ (3)
wherein

$$R = [ \begin{matrix}0 & 0 \\ {I}_{7} & 0\end{matrix} ] , S = [ \begin{matrix}0 & {I}_{1} \\ 0 & 0\end{matrix} ] ,$$

Iₖ is an identity matrix having a size of k×k.

In FIG. 4B, B₀⁽¹⁾ signifies a left/upper block of a macro block to be currently extracted, at a one-pixel moved position leftward compared to the left/upper block of the previously extracted macro block. B₀⁽¹⁾ overlaps with B₀ by as much as 8×7 pixels and partially overlaps with A₀ and A₂. By using the fact, equation (4) for extracting B₀⁽¹⁾ can be expressed as follows:

$${\hat{B}}_{0}^{( l )} = {\hat{B}}_{0} {\hat{R}}^{T} + {\sum }_{i = 0 , 2}^{} {\hat{P}}_{i} {\hat{A}}_{i} {\hat{W}}_{l} \qquad ( 4 )$$

wherein \hat{R}^{T}=DCT(R^{T})

$${W}_{l} = [ \begin{matrix}0 & 0 \\ {U}_{8 - {( mx )}_{8}} & 0\end{matrix} ] ,$$

and Uₖ has a size of k×k and is a matrix of which only the component (0,0) is 1 and the other components are all 0.

In a similar manner, as shown in FIG. 5A, B₀^{(u)} is at a one pixel-shifted position upward compared to B₀ and can be extracted by equation (5) shown below:

$${\hat{B}}_{0}^{( u )} = \hat{R} {\hat{B}}_{0} + {\sum }_{i = 0 , 1}^{} {\hat{W}}_{u} {\hat{A}}_{i} {\hat{Q}}_{i} \qquad ( 5 )$$

$$wherein {W}_{u} = [ \begin{matrix}0 & {U}_{8 - {( my )}_{8}} \\ 0 & 0\end{matrix} ] .$$

Also, as shown in FIG. 5B, B₀^{(d)} is at a one pixel-shifted position downward compared to B₀ and can be extracted by equation (6) shown below:
\hat{B}₀^{(d)}=\hat{R}^{T}\hat{B}₀+Ŝ^{T}\hat{B}₂ (6)
wherein Ŝ^{T}=DCT(S^{T}).

Accordingly, if dir is (r, l, u, d), \hat{B}₀^{(dir)} can be extracted by using the information overlap. That is, four luminance component blocks (B₀) can be obtained depending on each type that the data information of the previously extracted macro block, and the data information of the macro block to be currently extracted, overlap with each other.

If dir is (r,l,u, d), four values of \hat{B}₁^{(dir)} can be extracted by using the information overlap as follows:

$$\begin{matrix}{\hat{B}}_{1}^{( r )} = {\hat{B}}_{1} \hat{R} + {\sum }_{i = 1 , 3}^{} {\hat{P}}_{i} {\hat{A}}_{i} {\hat{W}}_{r} & ( 7 ) \\ {\hat{B}}_{1}^{( 1 )} = {\hat{B}}_{1} {\hat{R}}^{T} + {\hat{B}}_{0} {\hat{S}}^{T} & ( 8 ) \\ {\hat{B}}_{1}^{( u )} = \hat{R} {\hat{B}}_{1} + {\sum }_{i = 0 , 1}^{} {\hat{W}}_{u} {\hat{A}}_{i} {\hat{Q}}_{i} & ( 9 ) \\ {\hat{B}}_{1}^{( d )} = {\hat{R}}^{T} {\hat{B}}_{1} + {\hat{S}}^{T} {\hat{B}}_{3} & ( 10 )\end{matrix}$$

wherein

$${W}_{r} = [ \begin{matrix}0 & {T}_{{( mx )}_{8}} \\ 0 & 0\end{matrix} ] ,$$

Tₖ has a size of k×k, of which only the component (k−1,k−1) is ‘1’ and the other components are all ‘0’.

If dir is (r,l,u,d), four values of \hat{B}₂^{(dir)} can be extracted by using the information overlap as follows:

$$\begin{matrix}{\hat{B}}_{2}^{( r )} = {\hat{B}}_{2} \hat{R} + {\hat{B}}_{3} \hat{S} & ( 11 ) \\ {\hat{B}}_{2}^{( l )} = {\hat{B}}_{2} {\hat{R}}^{T} + {\sum }_{j = 0 , 2} {\hat{P}}_{j} {\hat{A}}_{j} {\hat{W}}_{l} & ( 12 ) \\ {\hat{B}}_{2}^{( u )} = \hat{R} {\hat{B}}_{2} + \hat{S} {\hat{B}}_{0} & ( 13 ) \\ {\hat{B}}_{2}^{( d )} = {\hat{R}}^{T} {\hat{B}}_{2} + {\sum }_{j = 2 , 3} {\hat{W}}_{d} {\hat{A}}_{j} {\hat{Q}}_{j} & ( 14 )\end{matrix}$$

wherein

$${w}_{d} = [ \begin{matrix}0 & 0 \\ {T}_{{( my )}_{8}} & 0\end{matrix} ] .$$

If dir is (r,l,u,d), four values of \hat{B}₃^{(dir)} can be extracted by using the information overlap as follows:

$$\begin{matrix}{\hat{B}}_{3}^{( r )} = {\hat{B}}_{3} \hat{R} + {\sum }_{j = 1 , 3} {\hat{P}}_{j} {\hat{A}}_{j} {\hat{W}}_{r} & ( 15 ) \\ {\hat{B}}_{3}^{( l )} = {\hat{B}}_{1} {\hat{R}}^{T} + {\hat{B}}_{2} {\hat{S}}^{T} & ( 16 ) \\ {\hat{B}}_{3}^{( u )} = \hat{R} {\hat{B}}_{3} + \hat{S} {\hat{B}}_{1} & ( 17 ) \\ {\hat{B}}_{3}^{( d )} = {\hat{R}}^{T} {\hat{B}}_{3} + {\sum }_{j = 2 , 3} {\hat{W}}_{d} {\hat{A}}_{j} {\hat{Q}}_{j} & ( 18 )\end{matrix}$$

As stated above, the equation used to extract each luminance component block (B₀˜B₃) of each current macro block differs depending on the value of offset motion vector δ . In this case δ is defined by δ ε{(1,0),(−1,0),(0,1),(0,−1)}.

Accordingly, in the present invention, the overlap degree between the data information of the previously extracted macro block and the data information of the macro block to be currently extracted is detected, and the above equations are suitably used to extract luminance component blocks of the current macro block.

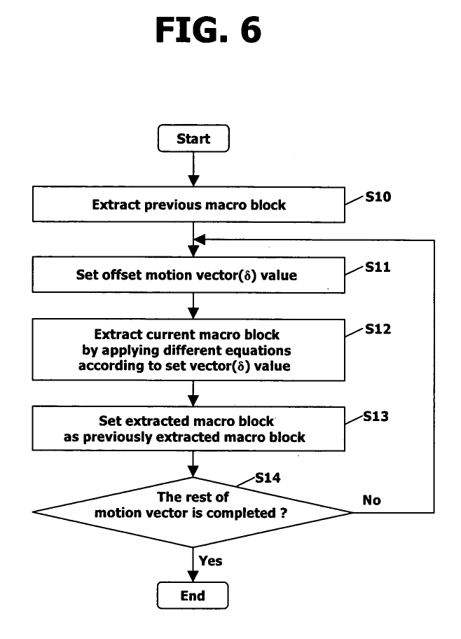

FIG. 6 is a flow chart of a macro block extracting method in accordance with an embodiment of the present invention.

As shown in FIG. 6, first, a macro block indicated by an initial motion vector is extracted (step S10) through equation (2). Meanwhile, it can be assumed that, in an initial operation, there already exist an initial motion vector and the macro block information extracted by equation (2).

Thereafter, an overlap degree between the previously extracted macro block information and the information on the macro block to be currently extracted is detected, to set an offset motion vector (δ) value (step S11). As the offset motion vector (δ) value is set, respective lumninance component blocks (B₀˜B₃) in the current macro block are extracted by applying a pertinent equation according to the corresponding (δ) value (step S12).

In other words, if the offset motion vector (δ) value is (1,0), B₀^{(r)}, B₁^{(r)}, B₂^{(r)}, B₃^{(r)} are extracted by using equations (3), (7), (11) and (15). If the offset motion vector (δ) value is (“1,0), B₀^{(l)}, B₁^{(l)}, B₂^{(l)}, B₃^{(l)} are extracted by using equations (4), (8), (12) and (16). If the offset motion vector (δ) value is (0,1), B₀^{(u)}, B₁^{(u)}, B₂^{(u)}, B₃^{(u)} are extracted by using equations (5), (9), (13) and (17). If the offset motion vector (δ) value is (0,−1), B₀^{(d)}, B₁^{(d)}, B₂^{(d)}, B₃^{(d)} are extracted by using equations (6), (10), (14) and (18).

Thus, the luminance component blocks (B₀˜B₃) of each macro block can be extracted by using suitable equations depending on the type of overlap between the previously extracted macro block information and the macro block information to be currently extracted.

Once the current macro block is extracted, it is set as a previously extracted macro block (step S13). Accordingly, a motion vector indicating the currently set macro block is re-set.

Thereafter, it is checked whether the motion vector re-setting has been completed (step S14). If the motion vector re-setting has been completed, every process is terminated. If, however, the motion vector re-setting has not been completed, it returns to the step S11 to repeatedly perform the process.

As so far described, the method for extracting a macro block at a high speed of the present invention has the following advantages.

For example, by extracting a macro block using an overlap phenomenon between previously extracted macro block information and macro block information to be currently extracted, the amount of calculation can be considerably reduced compared to conventional macro block extracting methods. If i ε{0,1,2,3} for \hat{B}ᵢ^{(dir)} and dir ε{r,l,u,d} and a block to be currently extracted completely overlaps a previously extracted macro block, equations (3) and (6) would be used. If a block to be currently extracted does not completely overlap with a previously extracted macro block but partially overlaps with Aᵢ, equations (4) and (5) would be used.

Accordingly, when a macro block at a one pixel-shifted position from a previously extracted macro block is extracted, information overlapping by as much as 16×15 or 15×16 is used. In this case, the required amount of calculation is merely (2×2+2×5)N³ or 14N³ times of multiplication and (2×2+2×5) 14N^{2.}(N−1) or 14N²·(N−1) times of addition. This means that the present invention reduces calculation by 56% compared to the conventional method in which the amount of calculation required up to (4×8)N³ or 32N³ times of multiplication and (4×8)N^{2.}(N−1) or 32N²·(N−1) times of addition.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

1. A macro block extracting method in a wireless system in which a motion vector in a discrete cosine transform region is reset for a video content service between a network and a terminal, comprising:
extracting a previous macro block indicated by an initial motion vector; and
extracting a current macro block by using an overlap degree between the extracted previous macro block information and current macro block information.

2. The method of claim 1, wherein said extracting the current macro block comprises:
setting an offset motion vector value by detecting the overlap degree between the extracted previous macro block information and current macro block information; and
obtaining luminance component blocks of the current macro block according to the set offset motion vector value.

3. The method of claim 2, wherein the offset motion vector has a form of (1,0), (−1,0), (0,1) and (0,−1).

4. The method of claim 2, wherein when the offset motion vector is (1,0), first to fourth luminance component blocks (\hat{B}₀^{(r)}−\hat{B}₃^{(r)} are determined as:
$$\begin{matrix}{\hat{B}}_{0}^{( r )} = {\hat{B}}_{0} \hat{R} + {\hat{B}}_{1} \hat{S} \\ {\hat{B}}_{1}^{( r )} = {\hat{B}}_{1} \hat{R} + {\sum }_{i = 1 , 3} {\hat{P}}_{i} {\hat{A}}_{i} {\hat{W}}_{r} \\ {\hat{B}}_{2}^{( r )} = {\hat{B}}_{2} \hat{R} + \hat{{B}_{3}} \hat{S} \\ {\hat{B}}_{3}^{( r )} = {\hat{B}}_{3} \hat{R} + {\sum }_{j = 1 , 3} {\hat{P}}_{j} {\hat{A}}_{j} {\hat{W}}_{r}\end{matrix}$$
wherein \hat{B}₀−\hat{B}₃ indicate first to fourth luminance components of the previously extracted macro block, Âᵢ and Âⱼ are discrete cosine transforms of blocks of a reference image,
$${P}_{1} = [ \begin{matrix}0 & {I}_{8 - {( my )}_{8}} \\ 0 & 0\end{matrix} ] , {P}_{3} = [ \begin{matrix}0 & 0 \\ {I}_{{( my )}_{8}} & 0\end{matrix} ] ,$$
Iₙ is a unit matrix having a size of n×n, mx and my are horizontal and vertical components of the motion vector, (mx)₈ and (my)₈ are values of modulo 8 value of mx and my, respectively, and 0s expressed in P₁ and P₃ are a zero matrix having a certain dimension,
$$R = [ \begin{matrix}0 & 0 \\ {I}_{7} & 0\end{matrix} ] , S = [ \begin{matrix}0 & {I}_{1} \\ 0 & 0\end{matrix} ] ,$$
Iₖ is an identity matrix having a size of k×k,
$${w}_{r} = [ \begin{matrix}0 & {T}_{{( mx )}_{8}} \\ 0 & 0\end{matrix} ] ,$$
and Tₖ has a size of k×k, of which only the component (k−1,k−1) is 1 while the other components are 0.

5. The method of claim 4, wherein Âᵢ (i=1,3) indicates second and fourth blocks in the reference image.

6. The method of claim 2, wherein when the offset motion vector is (−1,0), first to fourth luminance component blocks (\hat{B}₀^{(l)}−\hat{B}₃^{(l)}) are determined as:
$$\begin{matrix}{\hat{B}}_{0}^{( l )} = {\hat{B}}_{0} {\hat{R}}^{T} + {\sum }_{i = 0 , 2} {\hat{P}}_{i} {\hat{A}}_{i} {\hat{W}}_{l} \\ {\hat{B}}_{1}^{( l )} = {\hat{B}}_{1} {\hat{R}}^{T} + {\hat{B}}_{0} {\hat{S}}^{T} \\ {\hat{B}}_{2}^{( l )} = {\hat{B}}_{2} {\hat{R}}^{T} + {\sum }_{j = 0 , 2} {\hat{P}}_{j} {\hat{A}}_{j} {\hat{W}}_{l} \\ {\hat{B}}_{3}^{( l )} = {\hat{B}}_{1} {\hat{R}}^{T} + {\hat{B}}_{2} {\hat{S}}^{T}\end{matrix}$$
wherein \hat{B}₀−\hat{B}₃ indicate first to fourth luminance components of the previously extracted macro block, Âⱼ and Âⱼ are discrete cosine transforms of blocks of a reference image,
$${P}_{0} = [ \begin{matrix}0 & {I}_{8 - {( my )}_{8}} \\ 0 & 0\end{matrix} ] , {P}_{2} = [ \begin{matrix}0 & 0 \\ {I}_{{( my )}_{8}} & 0\end{matrix} ] ,$$
Iₙ is a unit matrix having a size of n×n, mx and my are horizontal and vertical components of the motion vector, (mx)₈ and (my)₈ are values of modulo 8 of mx and my, respectively, and 0s expressed in P₀ and P₂ are a zero matrix having a certain dimension, \hat{R}^{T}=DCT(R^{T}),
$${W}_{l} = [ \begin{matrix}0 & 0 \\ {U}_{8 - {( my )}_{8}} & 0\end{matrix} ] ,$$
Ŝ^{T}=DCT(S^{T}) and Uₖ is a matrix having a size of k×k of which only the component (0,0) is 1 while the other remaining components are all 0.

7. The method of claim 5, wherein Âᵢ(i=0,2) indicates first and third blocks in the reference image.

8. The method of claim 2, wherein when the offset motion vector is (0,1), first to fourth luminance component blocks (\hat{B}₀^{(u)}−\hat{B}₀^{(u)}) are determined as:
$${\hat{B}}_{0}^{( u )} = \hat{R} {\hat{B}}_{0} + {\sum }_{i = 0 , 1} {\hat{W}}_{u} {\hat{A}}_{i} {\hat{Q}}_{i}$$
$${\hat{B}}_{1}^{( u )} = \hat{R} {\hat{B}}_{1} + {\sum }_{i = 0 , 1} {\hat{W}}_{u} {\hat{A}}_{i} {\hat{Q}}_{i}$$
$${\hat{B}}_{2}^{( u )} = \hat{R} {\hat{B}}_{2} + \hat{S} {\hat{B}}_{0}$$
$${\hat{B}}_{3}^{( u )} = \hat{R} {\hat{B}}_{3} + \hat{S} {\hat{B}}_{1}$$
wherein \hat{B}₀−\hat{B}₃ indicate first to fourth luminance components of the previously extracted macro block, Âᵢ is a discrete cosine transform of blocks of a reference image,
$${Q}_{0} = [ \begin{matrix}0 & 0 \\ {I}_{8 - {( mx )}_{8}} & 0\end{matrix} ] , {Q}_{1} = [ \begin{matrix}0 & {I}_{{( mx )}_{8}} \\ 0 & 0\end{matrix} ] ,$$
Iₙ is a unit matrix having a size of n×n, mx and my are horizontal and vertical components of the motion vector,(mx)₈ and (my)₈ are values of modulo 8 of mx and my, respectively, and 0s expressed in Q₀ and Q₁ are a zero matrix having a certain dimension,
$$R = [ \begin{matrix}0 & 0 \\ {I}_{7} & 0\end{matrix} ] and S = [ \begin{matrix}0 & {I}_{1} \\ 0 & 0\end{matrix} ]$$
where Iₖ is an identity matrix having a size of k×k,
$${w}_{u} = [ \begin{matrix}0 & {U}_{8 - {( my )}_{8}} \\ 0 & 0\end{matrix} ]$$
and Uₖ is a matrix having a size of k×k of which only the component (0,0) is 1 while the other remaining components are all 0.

9. The method of claim 8, wherein Âᵢ(i=0,1) indicates first and second blocks in the reference image.

10. The method of claim 2, wherein when the offset motion vector is (0,−1), first to fourth luminance component blocks (\hat{B}₀^{(d)}−\hat{B}₃^{(d)}) are determined as:
$${\hat{B}}_{0}^{( d )} = {\hat{R}}^{T} {\hat{B}}_{0} + {\hat{S}}^{T} {\hat{B}}_{2}$$
$${\hat{B}}_{1}^{( d )} = {\hat{R}}^{T} {\hat{B}}_{1} + {\hat{S}}^{T} {\hat{B}}_{3}$$
$${\hat{B}}_{2}^{( d )} = {\hat{R}}^{T} {\hat{B}}_{2} + {\sum }_{j = 2 , 3} {\hat{W}}_{d} {\hat{A}}_{j} {\hat{Q}}_{j}$$
$${\hat{B}}_{3}^{( d )} = {\hat{R}}^{T} {\hat{B}}_{3} + {\sum }_{j = 2 , 3} {\hat{W}}_{d} {\hat{A}}_{j} {\hat{Q}}_{j}$$
wherein \hat{B}₀−\hat{B}₃ indicate first to fourth luminance components of the previously extracted macro block, Âⱼ is a discrete cosine transform of blocks of a reference image,
$${Q}_{2} = [ \begin{matrix}0 & 0 \\ {I}_{8 - {( mx )}_{8}} & 0\end{matrix} ] , {Q}_{3} = [ \begin{matrix}0 & {I}_{{( mx )}_{8}} \\ 0 & 0\end{matrix} ] ,$$
Iₙ is a unit matrix having a size of n×n, mx and my are horizontal and vertical components of the motion vector, (mx)₈ and (my)₈ are values of modulo 8 of mx and my, respectively, and 0s expressed in Q₂ and Q₃ are a zero matrix having a certain dimension, \hat{R}^{T}=DCT(R^{T}), wherein Ŝ^{T}=DCT(S^{T}) and
$${w}_{d} = [ \begin{matrix}0 & 0 \\ {T}_{{( my )}_{8}} & 0\end{matrix} ] .$$

11. The method of claim 10, wherein Âᵢ (i=2,3) indicates third and fourth blocks in the reference image.

12. A method of re-setting a motion vector, comprising:
extracting a first macro block; and
extracting a second macro block,
wherein said second macro block is extracted using an overlap degree between said first macro block and said second macro block.

13. The method of claim 12, wherein said first macro block is indicated by an initial motion vector.

14. The method of claim 12, wherein said motion vector is in a discrete cosine transform region.

15. The method of claim 12, wherein said overlap degree is an overlap between said first macro block and said second macro block.

16. The method of claim 12, wherein said extracting said second macro block further comprises setting an offset motion vector value and obtaining luminance component blocks of said second macro block based on said offset motion vector value.

17. The method of claim 16, wherein setting said offset motion vector value further comprises detecting said overlap degree.
